(19) United States
(12) Patent Application Publication
(10) Pub. No.: US 2011/0128121 A1
(43) Pub. Date: Jun. 2, 2011

(54) REMOTE ACCESS PROCEDURE FOR ELECTRONIC LOCKS

(76) Inventors: Yosi Shachar, Thomhill (CA); Lucian Panov, Thornhill (CA)

(21) Appl. No.: 12/723,737

(22) Filed: Mar. 15, 2010

(30) Foreign Application Priority Data
Dec. 2, 2009 (CA) 2,686,844

(51) Int. Cl. G05B 19/048

(52) U.S. Cl. 340/5.24

(57) ABSTRACT

There is provided an electronic lock and method for unlocking an electronic lock using an access code. In particular, the electronic lock of the present disclosure may be unlocked by an authorized user even if the access code is forgotten or lost. The electronic lock generates a random number, which a user may provide, after having been authenticated, to a remote location, where the random number is used to compute a temporary access code using a secret algorithm. This same secret algorithm is also present on the electronic lock, and therefore the electronic lock may recognize the temporary access code when entered by the user.

### REFERENCE TO RELATED APPLICATION

This application claims priority to Canadian patent application No. 2,686,844, filed Dec. 2, 2009, the disclosure of which is incorporated herein by reference.

### FIELD OF THE INVENTION

The present disclosure relates to a method and apparatus for providing remote access to an authorized user of a service. In particular, the present disclosure relates to a method and apparatus for providing remote access to an electronic lock

### BACKGROUND

For a number of applications today, it is preferable to protect property using an electronic lock instead of a mechanical lock and key mechanism. As is well known, such electronic locks may be activated using an entry code, key fobs, biological features such as a retina or fingerprints, and others. The present method and apparatus however, is particularly applicable to electronic locks activated by an entry code.

As is also well known, one drawback from having an electronic lock which is unlocked by providing an entry code is that a person may forget or otherwise lose access to the code. Mechanical locks are usually associated to a master key, usually held by the lock manufacturer, which can open a lock in the event the lock's actual key is lost.

Electronic locks may have a similar system by, for example, having a master code. In some cases, the master code may be associated to a lock's serial number, thus making the master code unique to a particular lock. However, such master codes can compromise the safety of all locks of a given manufacturer, or of a particular lock, should this code become known by unauthorized users. Moreover, it is preferable and more cost-effective to have a system which does not require an authorized employee of the lock manufacturer to visit a site.

Accordingly, there is a need for a method and apparatus allowing an authorized person to unlock an electronic lock for which the entry code was forgotten or is otherwise unavailable. In particular, there is need for such a method and apparatus which is practical, cost effective, and which does not compromise the security of the lock being unlocked or any other lock manufactured by the lock manufacturer.

### SUMMARY OF THE INVENTION

The present method and apparatus involve an electronic lock which is unlocked by providing the correct entry code. The electronic lock is equipped to generate a random code upon request by the user. The user must then communicate the code to a remote location, where the user's identity is verified. At the remote location, the random code is run through an algorithm which produces a temporary entry code. Since the electronic lock is also capable of running the algorithm, the electronic lock may be unlocked by entering the temporary entry code derived from the random code.

Therefore, according to one aspect of the present invention, there is provided a method for providing access to an electronic lock from a remote location, comprising the steps of: providing an identification code unique to the electronic lock; authenticating a user at the remote location; generating, at the electronic lock, a random code; communicating the random code to the remote location; computing, at the remote location, a temporary code based on the random code; communicating the temporary code to the authenticated user; and unlocking the electronic lock upon entry of the temporary code.

According to another aspect of the present invention, there is provided an electronic lock, comprising: a locking mechanism; an interface for entering a code; a processor, the processor being configured to: unlock the locking mechanism upon entry of a correct code; generate a random code; compute a temporary code from the random code using an algorithm; an output for communicating the random code to a user.

Various other aspects, features and advantages of the present invention will become readily apparent to those of ordinary skill in the art, and the novel features will be particularly pointed out in the appended claims.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a frontal view of an electronic lock interface according to an embodiment of the present invention; and

FIG. 2 is a flow chart of a method according to an embodiment of the present invention.

### DETAILED DESCRIPTION

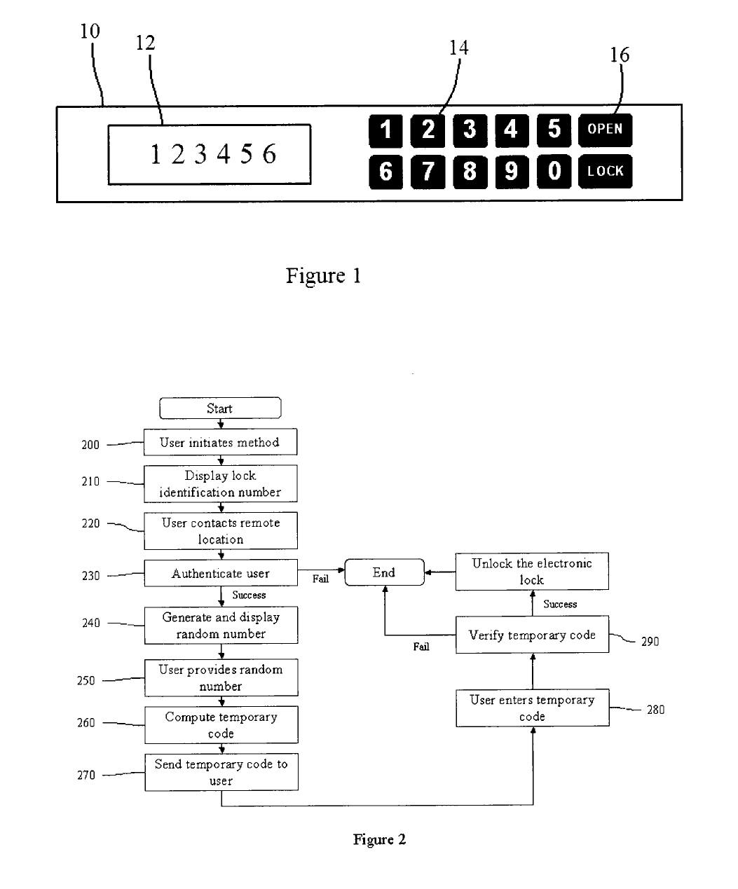

Reference is made to FIG. 1, which shows an exemplary interface of an electronic lock according to one embodiment of the present invention. As will be appreciated, the actual locking mechanism of the electronic lock can be any locking mechanism known in the art.

The lock interface 10 shown includes a display 12, a keypad 14, and buttons 16. The keypad 14 is shown as including only numbers, however it will be appreciated that some embodiments could also include letters and symbols, or any known means of entering a code. Also included in the lock is a processor (not shown) for receiving user input from the keypad 14 and buttons 16, controlling the display 12, locking and unlocking, and other functions as will be described below.

During normal operation, a user enters the code using keypad 14 and presses the “Open” button or the like, which opens the lock if the code is correct. Alternatively, the lock may open as soon as the correct code is entered. In order to close the lock, the user may simply close the lock mechanically or press a “Lock” button. In some embodiments it may be necessary to enter a locking code in order to close the lock.

According to some embodiments, the lock is programmable, thereby allowing the user to change codes, or to add a new code if the lock is adapted to accept more than one code as valid. A programmable lock typically accepts at least one code for unlocking, and at least one code for programming, which is typically made available only to persons of authority, such as a manager. When the administrative or programming code is entered, the lock enters programming mode and allows functions such as changing codes to be performed.

In the event that the authorized user of an electronic lock has forgotten or lost his unlocking code, the present method and apparatus allow the user to regain access to the lock without compromising its security or the security of any other lock.

The procedure for regaining access to the lock is best understood with reference to FIG. 2.

FIG. 2 shows a flow diagram of a method according to an embodiment of the present invention. The method starts at step 200, where the user initiates the method by, for example, entering a predefined code or by pressing a button provided specifically for that purpose. Other means of initiating the method would be known to those skilled in the art.

As will be appreciated by those skilled in the art, it is not desirable that the method be initiated accidentally, by, for example, pressing a button inadvertently. Accordingly, in embodiments where the method is initiated by the press of a button, it is preferable that the button be positioned at the back of the lock or in a depression on the surface of the lock in order to make it unlikely that it be pressed accidentally.

In embodiments where the method is initiated by entering a predefined code, there is obviously a risk that this code would also be lost or forgotten. Accordingly, the predefined code could be designed to be very easy to remember, like for example ‘00000000’. In other embodiments, the code could be provided in documentation associated with the lock, or could be provided on the lock itself As would be appreciated by a person skilled in the art, the present method can authenticate the user at a later stage and it is therefore not critical to prevent an unauthorized user to initiate the method.

In some embodiments, once the method is initiated, all previous codes are invalidated. In another embodiment, all codes except the administrative code are invalidated. In yet another embodiment, all codes remain valid. As would be appreciated by those skilled in the art, other schemes may be employed according to their suitability for any given application.

Returning now to FIG. 2, once the method is initiated by the user, the lock may provide the user at step 210, via the display or other output means, with a lock identification or serial code. The identification code is used in the authentication step, which is described in greater detail below. In some embodiments, the serial code may simply be displayed on the lock itself, on a sticker, engraved on the lock's exterior or the like.

Once the user has the identification code, the user may contact a remote location at step 220.

In at least one embodiment, this is done through a website maintained by the lock manufacturer. As provided in the method represented by FIG. 2, the user must be authenticated at step 230. Authentication may occur on a website by the user providing the electronic lock's identification code, and answering a number of questions about personal details known only to the lock's authorized user. Such personal details could include, but are not limited to, the user's mother's maiden name, place of birth, date of birth, social insurance number, postal code, secret password and the like, and would be provided by the authorized user while registering the electronic lock with the manufacturer. As would be appreciated by those skilled in the art, the level of security required for a given application would help to determine a specific method of authentication.

Alternatively, in at least one embodiment, the authentication step may be performed over the phone, either through an automated service, or by speaking to an operator. Any means of authenticating a person over the phone may be used, although for certain applications more rigorous methods should be used, as is known in the art. As with authentication over a website, authentication over the phone is typically done by the user providing the identification code and being asked for personal details which have been provided to the remote location for this purpose.

If authentication fails, the process ends. Otherwise, the process continues to step 240.

At step 240, a random code is generated by the lock and is displayed or otherwise provided to the user. The actual algorithm used to generate a random code is not critical to the present invention, but may be any suitable algorithm as is known in the art. Importantly however, the random code must have a sufficient number of digits and be sufficiently random so that it may not be easily guessed by an unauthorized user. In one embodiment, the random code has at least 8 alphanumeric characters. As will be appreciated by those skilled in the art, it is preferable that the likelihood of the same random code being generated twice be close to zero.

In at least some embodiments, the authentication step may be performed after the random code has been provided to the user.

Once the user is authenticated and a random code has been generated, the user is prompted by the website or the telephone operator to provide the randomly generated code received from the electronic lock. This is represented by step 250 of FIG. 2.

Once the remote location has received the identification code, the randomly generated code, and the user has been authenticated, a computer terminal at the remote location is fed the identification code and the randomly generated code, and outputs a temporary code for the electronic lock, at step 260 of FIG. 2. The temporary code is then communicated back to the user at step 270.

In one embodiment, it is possible that the algorithm produce a temporary code based only on the randomly generated code, without considering the identification code. However, as would be appreciated by those skilled in the art, such an embodiment would be less secure.

In another embodiment, the algorithm uses both the identification code and the randomly generated code.

As would be appreciated by the person skilled in the art, regardless of the embodiment, the algorithm is deterministic, meaning that for the same input, the same output is produced. In at least one embodiment, the algorithm is a pseudorandom generator seeded by a combination of the identification code and the randomly generated code.

The algorithm should also be designed such that it is essentially infeasible to determine what it is based on any number of known input/output pairs. As will be appreciated by the skilled person, the secrecy of the algorithm is what maintains an acceptable security level for a lock according to the present invention.

In order to further protect the secrecy of the algorithm, it is preferable that measures be taken at the remote location to protect the computer terminal which executes the algorithm. Such measures could include, but are not limited to, having the computer off-line, making it impervious to network based attacks (as would be appreciated, an off-line computer terminal would only be applicable in embodiments where the user contacts the remote location by phone), installing a firewall around the terminal, installing the terminal in a locked facility, and embedding the software implementing the algorithm in a microprocessor. Other measures would be known by those skilled in the art.

Once the user has the temporary code, he may enter it onto the electronic lock's keypad 14, as represented by step 280 of FIG. 2. The electronic lock is equipped with a microprocessor for running the same algorithm that was performed at the remote location in step 260. Since the algorithm is deterministic, the temporary code computed at the remote location should be the same as that computed by the electronic lock, because they both used the same inputs, namely the lock's identification number and the randomly generated number, which was computed by the electronic lock at step 220.

In a preferred embodiment, the lock's microprocessor has embedded thereon the software implementing the same algorithm that was run at the remote location, to ensure that the software cannot be extracted from the lock, as this would compromise the security of all similar locks.

At step 290, the processor of the electronic lock verifies that the code entered by the user matches the output of the algorithm as executed by the lock. If the code matches, the lock will unlock and allow the user to reprogram it. Otherwise, the lock remains locked.

The embodiments of the present invention described herein are intended to be non-limiting. Various modifications which are readily apparent to the person of skill in the art are intended to be within the scope of the invention, the only limitations to which are set forth in the appended claims.

We claim:

1. A method for providing access to an electronic lock from a remote location, comprising the steps of:
providing an identification code unique to the electronic lock;
authenticating a user at the remote location;
generating, at the electronic lock, a random code;
communicating the random code to the remote location;
computing, at the remote location, a temporary code based on the random code;
communicating the temporary code to the authenticated user; and
unlocking the electronic lock upon entry of the temporary code.

2. The method of claim 1, wherein the computing step uses an algorithm known to both the remote location and the electronic lock.

3. The method of claim 1, wherein the method is initiated by pressing a button.

4. The method of claim 1, wherein the method is initiated by entering a predefined code.

5. The method of claim 1, further comprising the step of invalidating previous codes.

6. The method of claim 1, further comprising the step of invalidating previous non-administrative codes.

7. The method of claim 1, wherein the step of unlocking the electronic lock further comprises the step of:
allowing the user to reprogram the electronic lock.

8. The method of claim 1, wherein the random code comprises at least eight alphanumeric digits.

9. The method of claim 1, wherein the remote location is a website.

10. The method of claim 1, wherein the remote location is a call center.

11. The method of claim 1, wherein the step of authenticating comprises:
verifying information known only to the authorized user.

12. The method of claim 11, wherein the information known only to the authorized user is at least one of the user's mother's maiden name, place of birth, date of birth, social insurance number, postal code, name of pet and secret password.

13. The method of claim 2, wherein the algorithm is deterministic.

14. An electronic lock, comprising:
a locking mechanism;
an interface for entering a code;
a processor, the processor being configured to:
unlock the locking mechanism upon entry of a correct code;
generate a random code; and
compute a temporary code from the random code using an algorithm; and
an output for communicating the random code to a user.

15. The lock according to claim 14, wherein the processor has embedded thereon software for computing a temporary code from the random code.

16. The lock according to claim 14, further comprising user-actuatable input which cause the processor to perform the steps of:
generate a random code; and
compute a temporary code from the random code.

17. The lock according to claim 16, wherein the user-actuatable input comprise a button.

18. The lock according to claim 14, wherein the lock further includes an identification code, the identification code uniquely identifying the lock.

19. The lock according to claim 18, wherein the processor is further configured to compute a temporary code from a combination of the random code and the identification code.

20. A system for providing access from a remote location to an electronic lock according to claim 14, comprising:
a mechanism for authenticating a user;
a receiver for receiving a randomly generated code from the user;
a processor configured to compute a temporary code from the randomly generated code using an algorithm; and
a transmitter for transmitting the temporary code to the user;
wherein the algorithm used by the processor is the same as the algorithm used by the processor of the electronic lock.
